(19) United States
(12) Patent Application Publication
(10) Pub. No.: US 2010/0020545 A1
(43) Pub. Date: Jan. 28, 2010

(54) HIGH EFFICIENCY BEAM FORMING LOUVER SYSTEM FOR TRADITIONAL POST-TOP GLOBES

(75) Inventor: Gary Allen Steinberg, Flat Rock, NC (US)

Correspondence Address: FAY SHARPE LLP, 1228 Euclid Avenue, 5th Floor, The Halle Building, Cleveland, OH, 44115, US

(73) Assignee: General Electric Company

(21) Appl. No.: 12/179,258

(22) Filed: Jul. 24, 2008

(51) Int. Cl. F21V 7/00

(52) U.S. Cl. 362/297

(57) ABSTRACT

A post-top luminaire assembly directs light generally downwardly from a light source. A first portion of the light output from the light source also forms a first portion of the primary beam. A first reflector portion receives emitted light from the source and redirects a second portion of the light along a second angular range in conjunction with forming the primary beam with the first portion of light. A second reflector portion receives a third portion of the emitted light and redirects it along a third angular range particularly near the pole base, while a third reflector portion receives a fourth portion of the emitted light from the light source and redirects it along a fourth angular range. The second reflector portion provides for light around the lamp base, while the third reflector portion precludes light from passing directly for up-lighting purposes and directs it outwardly at a high angle.

### BACKGROUND OF THE DISCLOSURE

This disclosure relates to a light assembly, and particularly to a post-top luminaire. More specifically, the disclosure is directed to a modular louver system used to control photometric distribution of light that emanates from a globe. It will be appreciated, however, that this disclosure may relate to various aspects of the assembly and may find particular application in related lighting environments and assemblies.

Outdoor luminaires are often mounted on posts, and have a nostalgic, historical aspect and aesthetic appeal, as well as providing a desired light output. Known arrangements, often include a globe that has a historical, acorn shape mounted atop a light pole or post. The globe has a relatively large internal cavity that receives a light source and any associated reflector assembly. To accommodate the light source and reflector assembly, the globe is usually split into first and second portions along the generally widest diameter portion of the globe so that the internal light source and optical control elements can be easily inserted into the globe cavity.

There is a desire to control the light output from lamps or luminaires of this type, however, prior arrangements have been deemed inadequate for one reason or another. For example, the efficiency of known arrangements is generally low and light distribution suffers from a lack of proper design. One area of light distribution that is substantially wasted is associated with up-lighting. Known arrangements purposefully direct a portion of light output from the light source toward an upper end of the globe where such up-light has virtually no impact on the desired lighting at street level around the base perimeter of the lamp post. Although such up-lighting allegedly provides an aesthetic appeal, purposefully directing a portion of the light output for up-lighting is deemed wasteful since sufficient up-lighting if desired will be provided by scattered light. In still other instances, multiple louvers used in an effort to provide precise control and limit the potential for any direct light or glare emanating from the light source result in unnecessary loss of light.

As noted, the typical, traditional, blow-molded textured acorn globe must usually be cut and re-bonded in order to assemble the light source and louver inside the globe. This adds undesired labor and increased costs to the final assembly. In some instances, the light source and associated louvers are mounted from this dividing plane in the globe. Further, a large number of optical components are often used and at a substantially increased overall cost. The louver assemblies are relatively complex, yet still do not provide desired efficiency and light control properties.

Thus, a need exists for improving the efficiency of a louver assembly, providing a more compact optical system, providing desired up-light control and lateral beam shaping, providing a manner to interface with a typical blow molded acorn globe without requiring cutting or rebonding of the globe top, using fewer and lower cost elements to construct the louver assembly, and reducing the complexity and overall cost of the post-top luminaire assembly.

### SUMMARY OF THE DISCLOSURE

A post-top luminaire assembly includes a light source mounted along a longitudinal lamp axis that emits a first portion of light along a first angular range. A first reflector portion receives a second portion of emitted light from the light source and redirects the second portion along a second angular range, while second and third reflector portions receive third and fourth portions of the emitted light, respectively, and redirect the third and fourth portions along third and fourth angular ranges.

The first and second angular ranges have a substantial overlap.

The first angular range is approximately between thirty to eighty degrees (30° to 80°) from the lamp axis, while the second angular range is approximately sixty to eighty degrees (60° to 80°) from the lamp axis. The third angular range is approximately twenty to forty (20° to 40°) from the lamp axis, and the fourth angular range is approximately seventy to eighty degrees (70° to 80°) from the lamp axis.

The assembly may also include an asymmetric reflector insert or a shield to block light over preselected segments or sectors.

The first, second and third reflector portions are mounted on a common structure and preclude light from the light source at an angle greater than approximately one hundred fifty degrees (150°) from the lamp axis from directly exiting the assembly, and eliminates directing any light from the light source for up-lighting purposes.

Preferably, the support structure is connected to a globe mounting member and the reflector portions are dimensioned for ease of insertion through one end of the lamp globe.

A primary benefit of the disclosure relates to the improved efficiency.

Another benefit resides in the compact optical system that controls up-lighting and lateral beam shaping.

Another advantage resides in the ability to interface with an acorn globe without requiring cutting and re-bonding of the globe top.

Still another advantage is associated with using fewer and lower-cost elements to construct the louver assembly while providing superior efficiency and light control properties.

Still other benefits and advantages of the present disclosure will become apparent from reading and understanding the following detailed description.

### BRIEF DESCRIPTION OF THE DRAWINGS

FIG. 1 is an elevational view, partly in cross-section, of a post-top luminaire or light assembly of the present disclosure.

FIG. 2 is a view similar to FIG. 1 with light ray traces shown in association with first, second, and third reflector portions.

FIG. 3 is a view similar to FIG. 2 with the addition of light ray traces associated with direct light output.

FIG. 4 is a perspective view of the louver assembly shown in FIGS. 1-3.

FIG. 5 is a view similar to FIG. 4 with the addition of an asymmetric insert.

FIG. 6 is a view similar to FIG. 4 with the addition of a shield.

### DETAILED DESCRIPTION OF THE PREFERRED EMBODIMENTS

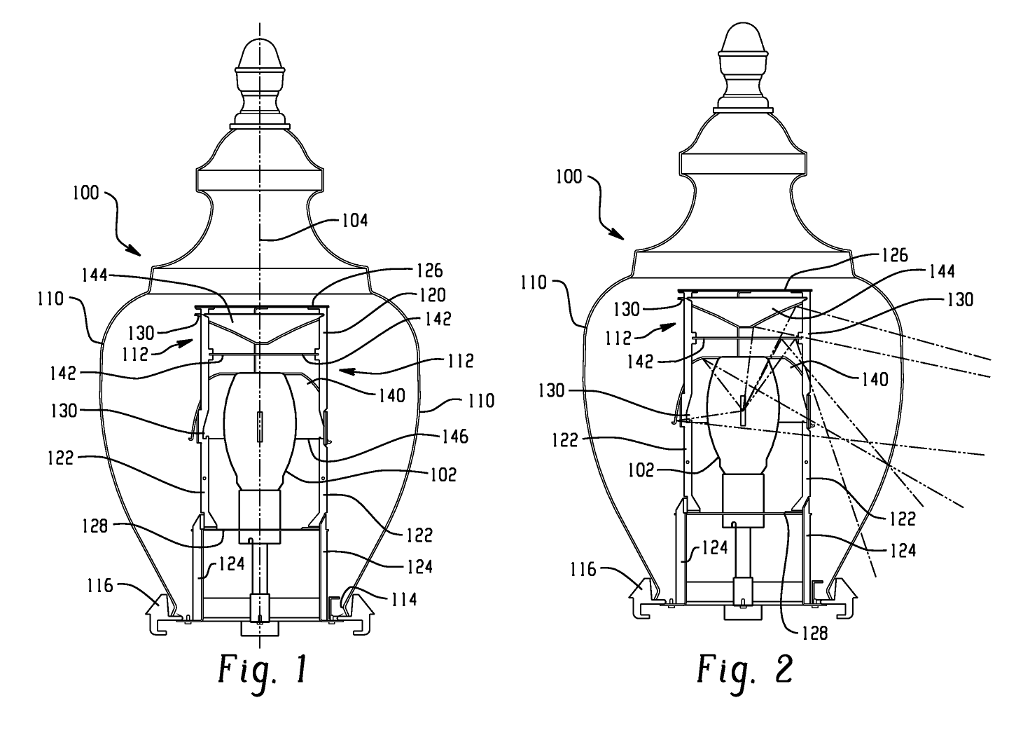

Turning first to FIGS. 1-3, a post-top luminaire or light assembly 100 is shown (without the post) and directs light generally downwardly from a light source 102. The light source 102, for example, may be an arc discharge lamp that has an envelope that is generally oriented along a longitudinal, central axis 104 of the luminaire assembly. More particularly, the light source is mounted at a desired location within an outer globe sometimes referred to as an acorn-shaped or acorn style globe 110.

As is typical, the globe is usually cut along the largest diameter portion so that the light source and associated louver assembly can be inserted within the globe cavity. However, this becomes labor intensive and it is preferable to provide a single-piece blow-molded globe, for example, that allows an alternative mounting of the light source and louver assembly therein. Here, the louver assembly 112 is of a compact design and dimensioned for receipt through opening 114 formed in a base of the globe. A globe mounting ring 116 is received around a base portion of the globe adjacent the opening and aids in mounting the same to the post top. The globe mounting ring in this arrangement is advantageously used as a mounting site or platform for the louver assembly in the present disclosure. The globe mounting ring 116 is preferably a twist-lock design for ease of securing the globe to the top of the post. Preferably, the globe is a single-piece blow-molded non-prismatic structure such as an acrylic and polycarbonate structure and although the globe is typically entirely light transmissive, there may be occasions where a selected portion (such as the upper portion) is opaque. It will also be appreciated that the acorn design is a typical, classical, nostalgic shape, although other globe shapes and configurations can be used without departing from the scope and intent of the present disclosure.

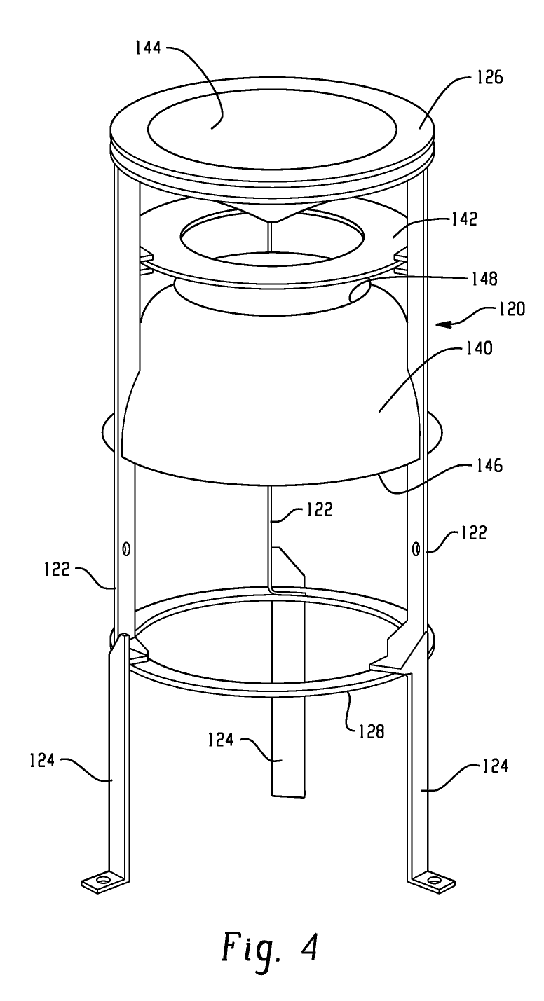

The light source 102 is usually supported on a ballast plate and fixture housing associated with the lamp post (not shown). A frame or mounting structure 120 for the louver assembly 112 preferably includes multiple support legs 122, generally equi-spaced around the light source (see also FIG. 4). The legs are generally thin or of a thin profile so as not to adversely impact on light output from the light source. Lower ends 124 of each leg are preferably fastened to the globe mounting ring via a suitable fastener. In the illustrated embodiment, three support legs (FIG. 4) are tied together by a first or upper frame ring 126 and a second or lower frame ring 128. Notches 130 (FIGS. 1-2) are provided at spaced axial locations along the frame legs 122 to receive first, second, and third reflector portions 140, 142, 144, respectively. The notches in the legs are preferably aligned in the same plane (although other mounting positions could be used) and allow for suitable interfit mounting of the individual reflector portions on the frame 120, as opposed to mechanical attachments such as rivets that are used to connect a louver assembly to a frame in prior arrangements.

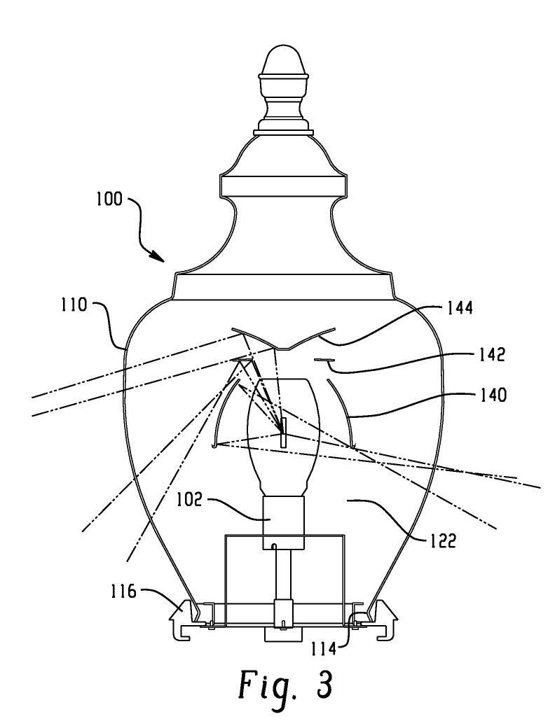

A first portion of the light that is output from the light source is exits the globe directly and forms a portion of a primary beam of the luminaire. This is best represented in FIG. 3 by the light ray traces between approximately thirty-two degrees (32°) and seventy-eight degrees (78°) from the lamp axis 104.

The first reflector portion 140 is a generally annular, concave shape located on the frame structure 120 such that a first lower, or larger diameter edge 146 is positioned just below approximately mid-height of the light source. A second upper, or smaller diameter edge 148 is substantially aligned or approximately co-terminus with an upper end of the light source, although this is not necessarily required. The first reflector portion 140 is suitably shaped so a second portion of light from the light source impacts an internal reflective surface thereof and reflects in a controlled, desired direction. Thus, light that emanates from the light source is reflected by the first reflector portion and, along with the direct light, creates a primary beam that is directed downwardly and outwardly about the pole. More particularly, and as shown in FIGS. 2 and 3, the angle of direct energy light extends from approximately thirty-two to seventy-eight degrees from the lamp axis as noted above and provides a substantial overlap with a second portion of light that is directed through an angular range of approximately fifty-nine degrees to eighty-three degrees (59° to 83°) from the lamp axis by the first reflector portion 140. Thus, the first reflector portion prevents lamp direct energy at high angles and assists in creating the primary beam.

The second reflector portion 142 is intended to fill light where it is needed near or adjacent the pole base. Here, the preferred form of the second reflector portion is a generally shallow conical disk with a centrally positioned concentric opening that redirects a third portion of the light from the light source to near the pole base between approximately nineteen to thirty-nine degrees (19° to 39°) from the lamp axis. The use of a flat, conical element as the second reflector portion in conjunction with a relatively large opening at the top of the first reflector portion allows this second reflector portion to be advantageously used to fill the light almost straight down around the base of the pole.

The third reflector portion 144 differs substantially from prior art arrangements. Whereas prior structures desired to direct light upwardly into the upper portion of the globe, it has been found that sufficient up-lighting is provided by light scatter to serve this purpose. In the preferred embodiment, the light that contacts the third reflector portion is instead advantageously directed as a high angle beam in a region approximately seventy-five degrees (75°) from the lamp axis. As noted in the light ray traces of FIGS. 2 and 3, this high angle beam is substantially collimated light. Most importantly, however, the third reflector does not allow this fourth portion of the light energy to pass unreflected into the up-lighting of the upper portion of the acorn globe, but instead directs it outwardly as a high angle beam. Thus, the third reflector portion is a generally inverted conical configuration that precludes passage of light to the upper portion of the globe.

As shown in FIG. 4, the three legs 122 are equi-spaced in the frame 120 and held at the upper end and adjacent the lower end by the frame rings 126, 128. In addition, lower ends of the legs 124 are secured to the globe mounting ring as described above. This provides for desired direction of light outwardly and downwardly through the globe and maximizes the efficiency of the lumen output. In addition, the louver assembly is a relatively compact structure that still permits assembly through the lower opening 114 in the one-piece globe (and likewise through the central opening of the globe mounting ring).

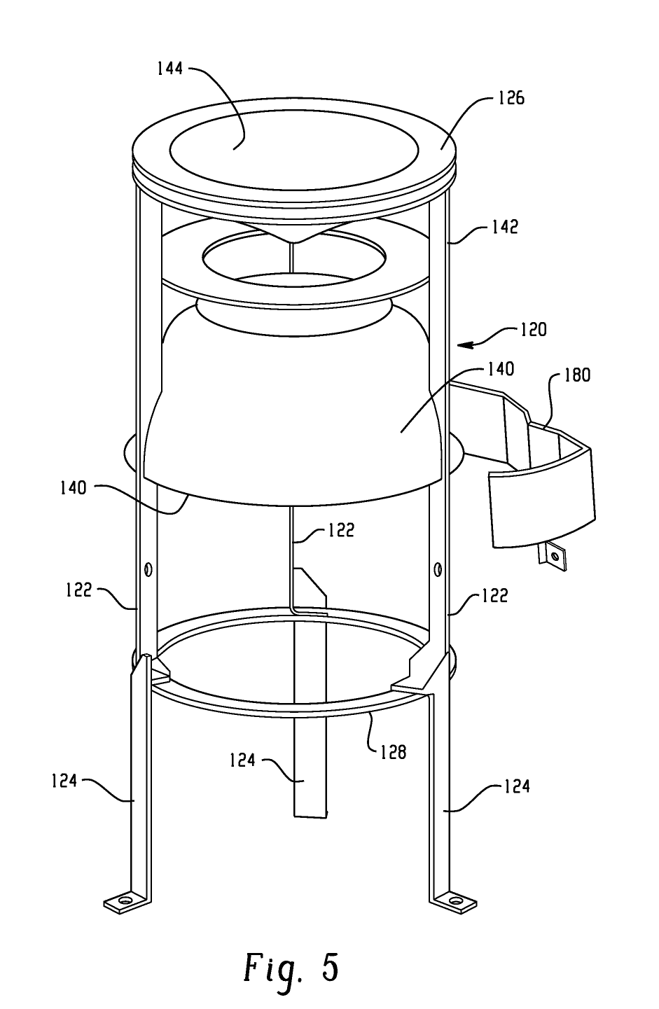

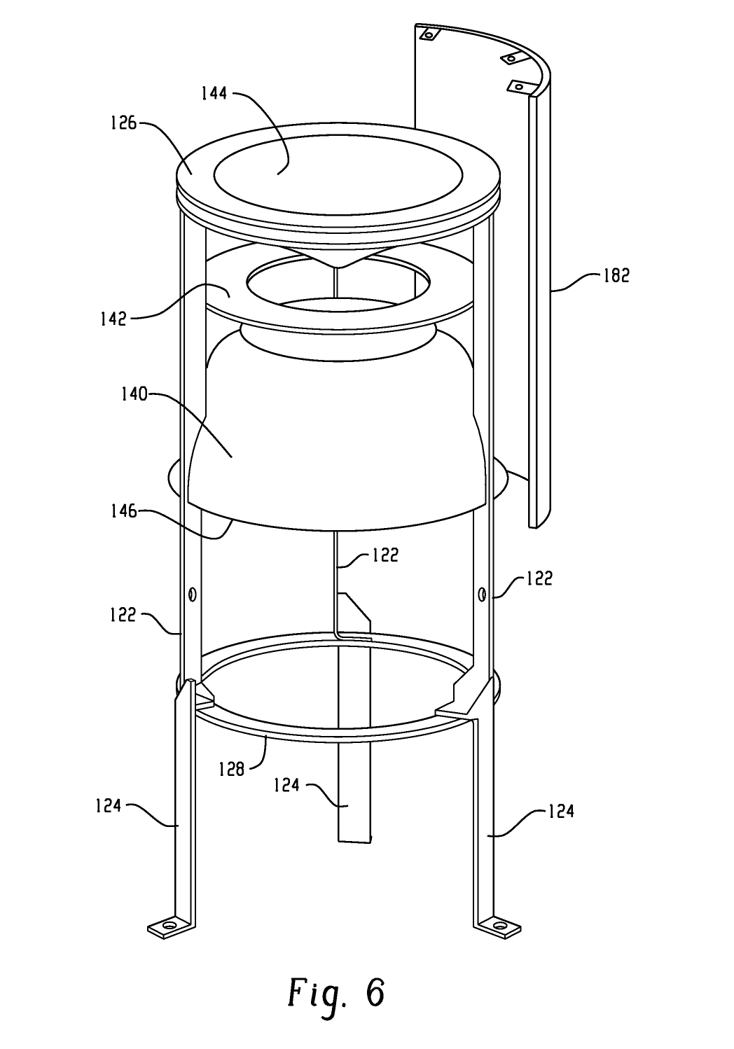

With additional reference to FIG. 5, an asymmetric reflector insert 180 may be provided along a selected portion of the frame structure 120, e.g., between the first and second legs of a frame structure. The insert can be secured to the legs through use of suitable fasteners that allows the designer to create an alternate photometric type from a basic symmetric assembly as shown in FIG. 4. Likewise, a house side shield 182 (FIG. 6) may be provided. As will be appreciated, the house side shield 182 prevents light from exiting the globe along this surface region of the globe. Again, the shield can be easily connected to the legs of the frame structure.

The present disclosure provides a reflective optical system designed to create a modular solution that can provide several light control configurations. The four basic elements of a small diameter concave reflective portion provide the primary uplight shielding function and provides a portion of the vertical light control. This component also provides rotationally symmetric beam patterns. An upper-most small diameter asymmetric shaped reflector portion controls the upper, central portion of light emitted from the light source and redirects the energy to useful vertical angles, while blocking up-light zones. This reflector component provides rotationally symmetric beam patterns also. The second, or middle, small diameter reflector portion controls additional up-light zones and redirects the light to fill downlight zones near the pole base. This component provides rotationally symmetric beam patterns. A bilaterally symmetric formed sheet metal asymmetric reflector insert may be added to the three symmetric elements to create an asymmetric beam pattern and improve the ratio of street-side to house-side lumens. In a similar fashion, a formed sheet metal shield can be added to the assembly to block light to the house side if so desired.

The resultant assembly is lighter weight which results in lower shipping costs. The compact, small-diameter louver assembly fits inside existing blow-molded single piece globes, again lowering the assembly effort and cost. By using fewer components, there are lower tooling costs and assembly costs associated with this arrangement. The present disclosure also meets light control specifications at higher efficiency than alternative solutions, and thereby increases the pole spacing and lowers the customer's infra-structure costs. The preferred embodiments provide a light control method that is inherently of higher efficiency and simpler, i.e., fewer components, than a conventional louvering system.

The invention has been described with reference to the preferred embodiments. Obviously, modifications and alterations will occur to others upon reading and understanding the preceding detailed description. It is intended that the invention be construed as including all such modifications and alterations.

What is claimed is:

1. A post top luminaire assembly for directing light downwardly from the light source comprising:
a light source mounted along a longitudinal, lamp axis and directly emitting a first portion of light along a first angular range;
a first reflector portion receiving a second portion of the emitted light from the light source and redirecting the second portion along a second angular range;
a second reflector portion receiving a third portion of the emitted light from the light source and redirecting the third portion along a third angular range; and
a third reflector portion receiving a fourth portion of the emitted light from the light source and redirecting the fourth portion along a fourth angular range wherein the third reflector portion precludes light from the light source at an angle greater than approximately one hundred fifty degrees from the lamp axis from directly exiting the assembly.

2. The luminaire assembly of claim 1 wherein the first reflector portion prevents direct energy light at high angles.

3. The luminaire assembly of claim 2 wherein the second angular range has a substantial overlap with the first angular range.

4. The luminaire assembly of claim 3 wherein the second angular range is approximately sixty to eighty degrees from the lamp axis.

5. The luminaire assembly of claim 4 wherein the first angular range is approximately between thirty to eighty degrees from the lamp axis.

6. The luminaire assembly of claim 2 wherein the first angular range is approximately between thirty to eighty degrees from the lamp axis.

7. The luminaire assembly of claim 1 wherein the second angular range is approximately sixty to eighty degrees from the lamp axis.

8. The luminaire assembly of claim 1 wherein the third angular range is approximately twenty to forty degrees from the lamp axis.

9. The luminaire assembly of claim 1 wherein the fourth angular range is approximately seventy to eighty degrees from the lamp axis.

10. The luminaire assembly of claim 1 wherein the first reflector portion precludes light from the light source from directly exiting the assembly at an angle between approximately eighty degrees and one hundred forty degrees from the lamp axis.

11. The luminaire assembly of claim 1 wherein the second reflector portion precludes light from the light source from directly exiting the assembly at an angle between approximately one hundred forty and one hundred sixty degrees from the lamp axis.

12. The luminaire assembly of claim 1 wherein the third reflector portion precludes light from the light source from directly exiting the assembly at an angle between approximately one hundred sixty and one hundred eighty degrees from the lamp axis.

13. The luminaire assembly of claim 1 further comprising an asymmetric reflector insert for additionally limiting light from the light source from directly exiting the assembly.

14. The luminaire assembly of claim 13 wherein the asymmetric reflector insert precludes a portion of the light from the light source from directly exiting the assembly at an angle less than approximately eighty degrees from the lamp axis.

15. The luminaire assembly of claim 1 further comprising a shield that blocks all light over a sector of approximately one hundred twenty degrees defined around the lamp axis.

16. The luminaire assembly of claim 1 further comprising a first support leg extending generally parallel to the lamp axis and interconnecting the first, second, and third reflector portions.

17. The luminaire assembly of claim 16 further comprising second and third support legs generally equi-spaced from the first support leg and interconnecting the first, second, and third reflector portions.

18. The luminaire assembly of claim 17 further comprising a generally annular frame member interconnecting the support legs.

19. The luminaire assembly of claim 16 wherein the first support leg is connected to a globe mounting member.

20. A post top light assembly comprising:
a light transmissive, globe forming an internal chamber;
a light source received in the globe along a substantially vertical axis and emitting a first portion of light directly through the globe;
a first reflector portion receiving a second portion of the emitted light from the light source and redirecting the second portion along a second angular range;
a second reflector portion receiving a third portion of the emitted light from the light source and redirecting the third portion along a third angular range;
a third reflector portion receiving a fourth portion of the emitted light from the light source and redirecting the fourth portion along a fourth angular range wherein the third reflector portion precludes light from the light source at an angle greater than approximately one hundred fifty degrees from the lamp axis from directly exiting the assembly; and
a support assembly dimensioned for mounting the reflector portions and light source through a lower opening in the globe.
